(19) United States
(12) Patent Application Publication
(10) Pub. No.: US 2010/0059348 A1
(43) Pub. Date: Mar. 11, 2010

(54) ACTUATING ELEMENT

(76) Inventor: Ronald Hauf, Mohrendorf (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/447,810

(22) PCT Filed: Oct. 18, 2007
(86) PCT No.: PCT/EP2007/061162

§ 371 Date: Apr. 29, 2009

(30) Foreign Application Priority Data
Oct. 30, 2006 (DE) 10 2006 051 140.9
Feb. 2, 2007 (DE) 10 2007 005 362.4

(51) Int. Cl. H01H 9/16

(52) U.S. Cl. 200/312; 200/310

(57) ABSTRACT

The invention relates to an actuating element (9) comprising a pushbutton (5) and a lamp (4) that surrounds the pushbutton (5). The pushbutton (5) generates a tactile feedback and the lamp (4) temporarily lights up when the pushbutton (5) is actuated. The invention creates an actuating element (9) for safely operating a machine and/or system, said actuating element (9) perceptibly providing a feedback to the user on his or her actuating the actuating element (9).

The invention relates to an actuating element.

Safety engineering has gained considerable importance with the entry into force of the 1995 EC machine guideline. The guideline has been converted into national law in all European countries and is thus compulsory for all machine manufacturers in the European Community. In non-European countries, comparable requirements often come indirectly from national product liability laws, for example in the USA and Japan, and so safety engineering is of worldwide importance.

This fact gives rise to a need for devices and functions on the market which enable and facilitate the implementation of the safety-related requirements.

In order to meet these safety-related requirements, so-called long-stroke keys are used in commercially available machines for the purpose of control, in particular as part of a control unit, for example a pushbutton panel or a machine pushbutton panel. However, long-stroke keys have a whole series of disadvantages on account of their design. For example, long-stroke keys do not provide the operator with any clear feedback (“spongy”) on when exactly the switching is carried out. Furthermore, long-stroke keys can be permanently changed to an intermediate position in which one contact has then switched but a second has not. In modern long-stroke keys, undesirable triggering of the so-called discrepancy monitoring often results since the two contacts of the long-stroke key often do not always switch at the same time, particularly if the long-stroke key is actuated slowly. As a result, this inevitably leads to a machine/system standstill. Furthermore, on account of their design, long-stroke keys have a large installation depth and, on account of their open construction, are sensitive to liquid, gaseous and, in particular, aggressive chemical substances. Modern long-stroke keys have many mechanical wearing parts, which makes customary long-stroke keys susceptible to faults. In addition, when actuating the key with a finger or the thumb, the light which is usually integrated in the long-stroke key is concealed.

The European laid-open specification EP 1 355 332 A2 discloses an electrical contact-making device.

The object of the present invention is to provide an actuating element for safely controlling a machine and/or system, which element provides an operator with clearly perceptible feedback on actuation of the actuating element.

This object is achieved by means of an actuating element, the actuating element having a pushbutton and a light which is arranged around the pushbutton, the pushbutton producing tactile feedback and the light lighting up briefly when the pushbutton is actuated.

Advantageous embodiments of the invention emerge from the dependent claims.

It proves to be advantageous if the light is in the form of a ring light since a ring light can be optically perceived in a particularly effective manner and the ring light is not concealed, for example by a finger, in particular by the operator's thumb, when the pushbutton is actuated.

It also proves to be advantageous if the light is in the form of an LED light. Designing the light in the form of an LED light allows a small installation depth and a long service life of the actuating element.

It also proves to be advantageous if the light is in the form of a multicolor LED light. The use of multicolor LEDs as luminous bodies makes it possible to indicate a plurality of signal states, in particular a plurality of actuation states.

Furthermore, it therefore proves to be advantageous if the actuating area of the pushbutton is at least 160 mm² or at least 280 mm². If the actuating area of the pushbutton has an appropriate size, unintentional actuation of the actuating element, for example if an adjacent actuating element is actuated, can be reliably avoided.

It also proves to be advantageous if the actuating area of the pushbutton has an inscription and/or a symbol. This conveys the significance of the actuating element to the operator in a simple manner.

It also proves to be advantageous if the inscription and/or the symbol is illuminated since the inscription and/or the symbol can then also be seen in the dark.

Furthermore, it proves to be advantageous if the actuating element is designed in such a manner that a brief acoustic signal can be generated when the pushbutton is actuated. In addition to tactile feedback and the optical feedback, this measure additionally also provides the operator with acoustic feedback which signals actuation of the actuating element.

It also proves to be advantageous if the actuating element has an acoustic signal generator as an integral part, the acoustic signal generator generating a brief acoustic signal when the pushbutton is actuated. If the signal generator needed to generate the acoustic signal is an integral part of the actuating element, it is possible to dispense with connecting an external acoustic signal generator to the actuating element.

Furthermore, it proves to be advantageous if the actuating element has an interface for driving an acoustic signal generator, the acoustic signal generator being driven by the actuating element in such a manner that the acoustic signal generator generates a brief acoustic signal when the pushbutton is actuated. If the acoustic signal generator is in the form of an external signal generator in this manner, the acoustic signals may be generated by a common acoustic signal generator if there are a plurality of actuating elements.

Furthermore, it proves to be advantageous if the interface is in the form of a switchable electrical contact or in the form of a bus interface. A switchable electrical contact or a bus interface for connecting a bus are conventional transmission interfaces.

Furthermore, it proves to be advantageous if the pushbutton has a switching element which adheres to a magnet when the pushbutton is not actuated and is released from the magnet when the pushbutton is actuated. This generates very good tactile feedback and avoids intermediate switching positions.

It also proves to be advantageous if the switching element has a connecting element, the distance between the connecting element and the magnet being at least 1 mm when the pushbutton is actuated, since the tactile feedback can thus be improved further.

It also proves to be advantageous if the pushbutton is in the form of a membrane pushbutton since no dust particles and no liquids can then enter the actuating element and damage the mechanism. Furthermore, there is no intermediate position when actuating the pushbutton on account of the construction. Switching a normally closed contact compulsorily switches a normally open contact and vice versa.

The actuating element according to the invention is particularly suitable for installation in a control unit, for example a control panel for controlling a machine.

Furthermore, it proves to be advantageous if the light lights up permanently or periodically in one color when the pushbutton is not actuated and the light lights up briefly in another color when the pushbutton is actuated. This makes it possible to indicate a plurality of signal states, in particular actuation states, to an operator.

Furthermore, it proves to be advantageous to design a machine tool, a production machine and/or a robot with the actuating element according to the invention and/or the control unit since this ensures safe control of these machines. However, it goes without saying that the actuating element according to the invention and/or the control unit can also be used for control in other fields of use, for example in process technology, in crane systems and in traffic technology and power plant technology, in cold storage warehouses and in the food sector.

One exemplary embodiment of the invention is illustrated in the drawing and is explained below. In the drawing:

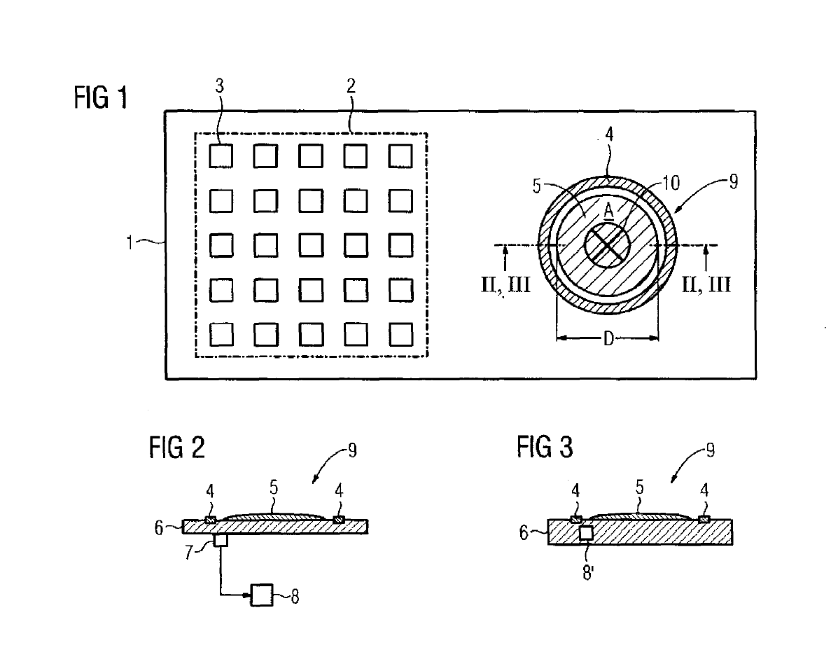

FIG. 1 shows a control unit having an actuating element,

FIG. 2 shows a sectional illustration of the actuating element,

FIG. 3 shows another embodiment of the actuating element, and

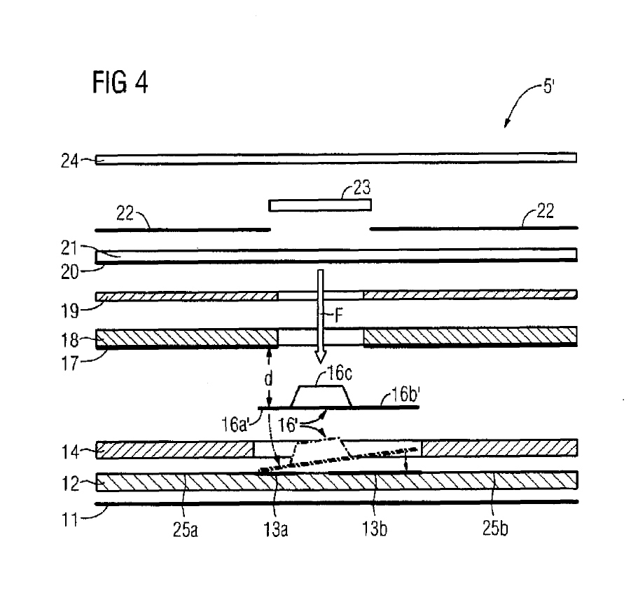

FIG. 4 shows an embodiment of the pushbutton in the form of a membrane pushbutton.

FIG. 1 schematically illustrates a control unit 1 for controlling a machine. The control unit 1 has a membrane keypad 2 having key elements, only one key element 3 being provided with a reference symbol for the sake of clarity. Furthermore, the control unit 1 has an actuating element 9 according to the invention for controlling functions, in particular safety-relevant functions of the machine. The actuating element 9 has a pushbutton 5 and a light 4 which is arranged around the pushbutton 5, the light 4 being in the form of a ring light within the scope of the exemplary embodiment. In this case, the ring light is in the form of an LED light. When the pushbutton 5 is actuated, that is to say when the pushbutton 5 is pressed, the pushbutton produces tactile feedback for the operator and the light 4 simultaneously lights up briefly and then goes out again immediately. Within the scope of the exemplary embodiment, the light 4 lights up briefly by virtue of the light flashing briefly. The operator is provided with feedback on proper actuation of the pushbutton by virtue of the tactile feedback in conjunction with the simultaneous lighting-up of the light.

In order to preclude inadvertent control actions, for example by virtue of an adjacent actuating element being pressed, the pushbutton 5 has a relatively large size. For example, the actuating area A (indicated using hatching in FIG. 1) of the pushbutton 5 is at least 160 mm². In order to preclude incorrect operation in a particularly reliable manner, the actuating area of the pushbutton may, however, also be at least 280 mm².

Within the scope of the exemplary embodiment, the diameter D of the circular pushbutton is 20 mm. Within the scope of the exemplary embodiment, the pushbutton 5 and the light 4 are circular. However, instead of the circular shape, the pushbutton 5 and/or the light 4 may also be square or triangular, for example. Any desired shape is conceivable, in principle. For identification, a symbol 10 is applied to the actuating area A of the pushbutton 5. Alternatively or additionally, the actuating area may also have an inscription.

In order to provide the operator with additional acoustic feedback, in addition to the tactile and optical feedback on the successful actuation of the pushbutton, when the pushbutton is actuated, a brief acoustic signal is generated when the pushbutton 5 is actuated. When the pushbutton is actuated, the tactile feedback and the brief lighting-up of the light and, if present, the sounding of the brief acoustic signal take place at the same time. In this case, the acoustic signal may be in the form of a bleep, for example.

FIG. 2 shows, in the form of a schematic illustration, a cross section through the actuating element according to the invention. The pushbutton 5 and the light 4 are arranged on a printed circuit board 6. Furthermore, the actuating element 9 has an interface 7 for driving an acoustic signal generator 8, the acoustic signal generator 8 being driven by the actuating element in such a manner that the acoustic signal generator 8 generates a brief acoustic signal when the pushbutton 5 is actuated. In this case, the acoustic signal generator 8 may be in the form of a bleeper, for example. The interface 7 may be in the form of a switchable electrical contact, which is closed briefly, for example when the pushbutton 5 is pressed, or else may be in the form of a bus interface for connecting a bus.

FIG. 3 illustrates another embodiment of the actuating element according to the invention. The basic construction of the embodiment illustrated in FIG. 3 essentially corresponds to that of the embodiment described above in FIG. 2. Therefore, in FIG. 3, the same elements are provided with the same reference symbols as in FIG. 2. The only fundamental difference is that the acoustic signal generator 8′ is an integral part of the actuating element 9 in the embodiment according to FIG. 3.

However, it goes without saying that it is also possible for the actuating element 9 according to the embodiment shown in FIG. 3 to also additionally have an interface for driving an additional acoustic signal generator like in the embodiment shown in FIG. 2.

The light lights up exactly at the time at which the pushbutton is switched. The acoustic signal (for example bleep) is generated exactly at the switching time. The tactile sense of touch, together with the optical and acoustic stimulus, is considerably heightened in the overall impression. A clear delimited sense of touch is produced by the up to triple superimposition of stimuli. The operator can clearly feel, see and hear the actuation of the keys. In this manner, the actuating element allows reliable control of the machine.

If the light is in the form of an LED light, it is advantageous to design it in the form of a multicolor LED light. The use of multicolor LEDs as luminous bodies makes it possible to indicate a plurality of signal states using the light. For example, when the pushbutton is not actuated, the light may light up permanently in one color (for example green), whereas, when the pushbutton is actuated, the light lights up briefly in another color (for example white).

It is also noted at this point that yet further actuating elements according to the invention may be arranged on the printed circuit board 6 in addition to the actuating element 9 illustrated.

It is also noted that the electrical contact-making device described in the European laid-open specification EP 1 355 332 A2 can be advantageously used, in particular, as the pushbutton since it has a particularly high degree of reliability and produces good tactile feedback.

FIG. 4 illustrates, in an exploded illustration, a sectional view of an exemplary embodiment of the pushbutton 5. In this case, the pushbutton 5 is in the form of a membrane pushbutton 5′. In this case, the light 4 may be integrated in a layer of the membrane pushbutton 5′. If necessary, if there are a plurality of such membrane pushbuttons, they may also be combined to form a membrane keypad.

The membrane pushbutton 5′ has a printed circuit board 12 having a front contact 13a and a rear contact 13b. The front contact 13a is electrically conductively connected to a front conductor track 25a and the rear contact 13b is electrically conductively connected to a rear conductor track 25b. A basic adhesive 11 can be used to fasten the printed circuit board 12 to the control unit 1 (see FIG. 1). A lower spacer 14 ensures a sufficient distance between a magnetic film carrier 18, to whose underside a magnetic film 17 which is used as a magnet is applied, and the printed circuit board 12. A switching element 16 having a hat 16c and a connecting element 16′ is arranged between the magnetic film carrier 18 and the printed circuit board 12, the hat 16c being arranged on the connecting element 16′ in an asymmetrical manner such that a short front part 16a′ and a longer rear part 16b′ are produced on the connecting element 16′. A small steel plate pressed into the appropriate shape is preferably used as the switching element 16.

When the membrane pushbutton 5′ is not actuated, the switching element 16 magnetically adheres to the magnetic film 17 on account of the magnetic force of attraction between the magnetic film 17 and the connecting element 16′. When the membrane pushbutton 5′ is actuated, a force F is exerted on the switching element from above, in the depiction according to FIG. 4, and presses the switching element 16 downward. If the force F is large enough, the short front part 16a′ is first of all released on account of the asymmetrical arrangement of the hat 16c on the connecting element 16′ and touches the front contact 13a. The longer rear part 16b′ is then abruptly released and touches the rear contact 13b. An electrically conductive connection between the front contact 13a and the rear contact 13b is established in this manner via the electrically conductive switching element 16. The operation is illustrated in FIG. 4 using dash-dotted lines. If the force F is reduced again upon completion of the actuating operation, the switching element 16 is pulled upward again by the magnetic film 17, which forms a magnet, and there is an abrupt interruption in the conductive connection between the contact 13a and the rear contact 13b. Very good tactile feedback is produced in this manner as a result of the switching element 16 being abruptly snapped up and down, and the pushbutton does not allow any intermediate switching position owing to its design. The tactile feedback is particularly good if the distance d (key movement) between the magnetic film (17) and the connecting element (16′) is at least 1 mm, in particular 1.5 mm, when the membrane pushbutton (5′) is actuated.

An upper spacer 19 ensures a sufficient distance between a ground contact layer carrier 21, to which a ground contact layer 20 is fastened, and the magnetic film carrier 18. When the membrane pushbutton is not actuated, the ground contact layer 20 touches the switching element 16 via the hat 16c and thus pulls the switching element 16 to ground potential. The upper spacer 19, the magnetic film carrier 18 and the magnetic film 17 each have a cutout for the hat 16c. The lower spacer 14 has a cutout for the switching element 16.

An overlay film 24 which is connected to the ground contact carrier 21 with the aid of an overlay adhesive 22 protects the membrane pushbutton 5′ from contamination. An insert strip 23, to which an inscription and/or a symbol for the pushbutton is applied (for example printed on), is arranged between the overlay film 24 and the ground contact carrier 21.

In order to enable a normally closed contact/normally open contact combination, the membrane pushbutton 5′ may have electrical contacts which open and close in an antivalent manner. The membrane pushbutton allows a defined switching time of less than 10 ms and is extremely insensitive to temperature and insensitive to electromagnetic waves (EMC, radio) and static discharges. The membrane pushbutton 5′ makes it possible to implement the IP67 type of protection and enables a low key profile and a small installation depth.

It is noted at this point that the principle of abruptly snapping the switching element 16 up and down using a magnet, as described above for the membrane pushbutton, can also be applied to a non-membrane pushbutton, with the result that a pushbutton constructed according to the magnetic principle described above need not necessarily be in the form of a membrane pushbutton but may also be in the form of a conventional pushbutton.

The above-described principle of abruptly snapping the switching element 16 up and down using a magnet also allows a small installation depth of the actuating element.

1-18. (canceled)

19. An actuating element, comprising:
a pushbutton constructed to produce a tactile feedback in response to an actuation of the pushbutton; and
a light arranged around the pushbutton and momentarily lighting up when the pushbutton is actuated.

20. The actuating element of claim 19, wherein the light is constructed in the form of a ring light.

21. The actuating element of claim 19, wherein the light is constructed in the form of an LED light.

22. The actuating element of claim 19, wherein the light is constructed in the form of a multicolor LED light.

23. The actuating element of claim 19, wherein the pushbutton has an actuating area which is at least 160 mm².

24. The actuating element of claim 19, wherein the pushbutton has an actuating area which is at least 280 mm².

25. The actuating element of claim 19, wherein the pushbutton has an actuating area which has at least one member selected from the group consisting of an inscription and a symbol.

26. The actuating element of claim 25, wherein the member is illuminated.

27. The actuating element of claim 19, wherein the pushbutton has an actuating area designed to generate a brief acoustic signal, when the pushbutton is actuated.

28. The actuating element of claim 19, further comprising an acoustic signal generator forming as an integral part of the actuating element and generating a brief acoustic signal when the pushbutton is actuated.

29. The actuating element of claim 19, further comprising an interface operatively connected to an acoustic signal generator which is rendered operative to generate a brief acoustic signal when the pushbutton is actuated.

30. The actuating element of claim 29, wherein the interface is configured as a member selected from the group consisting of a switchable electrical contact and a bus interface.

31. The actuating element of claim 19, wherein the light lights up permanently or periodically in one color in the absence of an actuation of the pushbutton and the light lights up briefly in another color when the pushbutton is actuated.

32. The actuating element of claim 19, wherein the pushbutton has a magnet and a switching element which adheres to the magnet in the absence of an actuation of the pushbutton and is released from the magnet when the pushbutton is actuated.

33. The actuating element of claim 32, wherein the switching element has a connecting element at a distance to the magnet of at least 1 mm when the pushbutton is actuated.

34. The actuating element of claim 19, wherein the pushbutton is constructed in the form of a membrane pushbutton.

35. A control unit, comprising an actuating element including a pushbutton constructed to produce a tactile feedback in response to an actuation of the pushbutton, and a light arranged around the pushbutton and momentarily lighting up when the pushbutton is actuated.

36. A machine tool, a production machine and/or a robot, comprising a control unit including an actuating element having a pushbutton constructed to produce a tactile feedback in response to an actuation of the pushbutton, and a light arranged around the pushbutton and momentarily lighting up when the pushbutton is actuated.

37. A machine tool, a production machine and/or a robot, comprising an actuating element including a pushbutton constructed to produce a tactile feedback in response to an actuation of the pushbutton, and a light arranged around the pushbutton and momentarily lighting up when the pushbutton is actuated.
